(19) United States
(12) Patent Application Publication
(10) Pub. No.: US 2025/0097346 A1
(43) Pub. Date: Mar. 20, 2025

(54) GENERATING CUSTOMIZED AUTHENTICATION QUESTIONS FOR AUTOMATED VISHING DETECTION

(71) Applicant: Bank of America Corporation, Charlotte, NC (US)

(72) Inventors: George Albero, Charlotte, NC (US); Maharaj Mukherjee, Poughkeepsie, NY (US)

(21) Appl. No.: 18/368,095

(22) Filed: Sep. 14, 2023

(51) Int. Cl. H04M 3/436

(52) U.S. Cl. CPC H04M 3/436

(57) ABSTRACT

A computing platform may train an identity verification model to identify authentication questions to validate an identity of an individual. The computing platform may detect a call of the individual. The computing platform may input, into the identity verification model and while the call is paused, information of the call, the individual, and/or a second individual, which may cause the identity verification model to output the authentication questions. The computing platform may send, while the call is paused and to a user device of the individual, the authentication questions. The computing platform may receive, while the call is paused and from the user device, authentication information comprising responses to the authentication questions. The computing platform may validate, while the call is paused, the authentication information. Based on successful validation of the authentication information, the computing platform may cause the call to resume.

### BACKGROUND

In some instances, enterprise organizations, such as financial institutions, merchants, service providers, and/or other enterprises, may provide service to their customers and/or clients. In some instances, these services may be provided through voice communication between individuals (e.g., customer service calls, or the like). In some instances, such communication may include confidential information, personal identifiable information, and/or other information that may be private to an individual on the call (e.g., a client, or the like). As lifelike chatbots, deepfakes, and/or other voice simulators become more prevalent and accurate, they may augment the problem of automated vishing. For example, such impersonation/simulation may result in the unintended sharing of private and/or other confidential information with unauthorized parties. Accordingly, it may be important to provide enhanced security mechanisms to detect and/or otherwise prevent vishing attacks.

### SUMMARY

Aspects of the disclosure provide effective, efficient, scalable, and convenient technical solutions that address and overcome the technical problems associated with authentication and impersonation detection. In one or more instances, a computing platform having at least one processor, a communication interface, and memory may train, using historical call information, an identity verification model, which may configure the identity verification model to identify, for an initiated call between a first individual and a second individual, one or more authentication questions to validate an identity of the first individual. The computing platform may detect a first call between the first individual and the second individual, where the first individual may be one of: an employee of an enterprise or an impersonator of the employee of the enterprise. The computing platform may temporarily pause the first call. The computing platform may input, into the identity verification model and while the first call is paused, information of one or more of: the first call, the first individual, or the second individual, where inputting the information causes the identity verification model to output the one or more authentication questions. The computing platform may send, while the first call is paused and to a user device of the first individual, the one or more authentication questions and one or more commands directing the user device of the first individual to present the one or more authentication questions, which may cause the user device of the first individual to output the one or more authentication questions. The computing platform may receive, while the first call is paused and from the user device of the first individual, authentication information comprising responses to the one or more authentication questions. The computing platform may validate, while the first call is paused, the authentication information. Based on successful validation of the authentication information, the computing platform may cause the first call to resume.

In one or more instances, the historical call information may include one or more of: employee information corresponding to the first individual, enterprise information corresponding to the enterprise, customer information corresponding to the second individual, account information corresponding to the second individual, or details of historical calls between the second individual and the enterprise. In one or more instances, the details of the historical calls between the second individual and the enterprise may include transcripts of the historical calls.

In one or more examples, the one or more authentication questions may include one or more personalized questions for the first individual. In one or more examples, the one or more authentication questions may prompt the first individual to verify one or more of: employee information corresponding to the first individual, enterprise information corresponding to the enterprise, customer information corresponding to the second individual, account information corresponding to the second individual, or details of historical calls between the second individual and the enterprise.

In one or more instances, outputting the one or more authentication questions may include outputting a sequence of at least two authentication questions, where the at least two authentication questions may be configured to be presented in the sequence and increase in specificity as the sequence progresses. In one or more instances, the computing platform may send, to a user device of the second individual and prior to sending the one or more authentication questions to the user device of the first individual, the one or more authentication questions and a request to confirm the one or more authentication questions.

In one or more examples, the request to confirm the one or more authentication questions may be a request to confirm one or more of: the one or more authentication questions are accurate measures for validating an identity of the first individual, or responses to the one or more authentication questions that may be used to validate the authentication information. In one or more examples, the first call may be initiated by one of: the first individual or the second individual.

In one or more instances, presenting the one or more authentication questions may include one or more of: displaying the one or more authentication questions on a graphical user interface of the user device of the first individual, or causing the one or more authentication questions to be presented, at the user device of the first individual, as an audio output. In one or more instances, receiving the authentication information may include receiving one or more of: 1) a user input via a graphical user interface of the user device of the first individual, where the user input may include one or more of: a selection of a user interface element corresponding to the authentication information, or a natural language input in a text input field, or 2) a voice input corresponding to the authentication information.

In one or more examples, validating the authentication information may include comparing the authentication information to known valid responses to the authentication questions. In one or more examples, based on failing to successfully validate the authentication information, the computing platform may: 1) identify that the first individual is an impersonator, 2) terminate the first call, and 3) initiate one or more security actions.

In one or more instances, the computing platform may update, using a dynamic feedback loop and based on the one or more authentication questions, the authentication information, the information of the first individual, the information of the second individual, or the information of the first call, the identity verification model. In one or more instances, updating the identity verification model may cause the identity verification model to perform one or more of: adding new authentication questions or removing the one or more authentication questions based on receiving consensus information from a plurality of individuals indicating that the one or more authentication questions resulted in one of: a false positive validation or a false negative validation. In one or more instances, detecting the first call between the first individual and the second individual may include detecting the first call by one of: a mobile device of the second individual being used to perform the first call, or a voice sensor attached to a landline phone being used to perform the first call.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for generating customized authentication questions for automated vishing detection in accordance with one or more example embodiments;

FIGS. 2A-2D depict an illustrative event sequence for generating customized authentication questions for automated vishing detection in accordance with one or more example embodiments;

FIG. 3 depicts an illustrative method for generating customized authentication questions for automated vishing detection in accordance with one or more example embodiments; and

FIGS. 4-6 depict illustrative user interfaces for generating customized authentication questions for automated vishing detection in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction of the concepts described in further detail below, systems and methods for generating customized authentication questions for automated vishing detection are described herein. For example, as lifelike chatbots and deepfake voice simulators become more accurate, the problem of automated vishing may become more and more prevalent. A customer may be fooled into sharing private and/or confidential information through vishing.

For example, as soon as a caller identifies themselves as an employee of an enterprise organization tied to an automated vishing mechanism (e.g., an agent, employee, or the like), the automated vishing prevention may go into effect. This may alert the customer that a vishing test is being run, and may mute the customer. The system may then ask the agent a few questions about the customer with answers only a live agent/employee may know or have access to. If the caller fails to answer the question or obfuscates, the call may be immediately blocked.

The autogenerated vishing system may be programmed to generate predetermined false answers in case the vishers have a credit report, account information, or the like. For example, the autogenerated vishing system may prompt the caller with “which of the following accounts am I associated with?” Where some (or all) of the listed accounts are fake. In some instances, the customer may provide an input (e.g., press nine on a keypad, or the like), which may trigger a predetermined false account response. The automated response actions may include sending a recording, a number called, a number dialed from, and/or other information to an authority. The automated response actions may further include sending automated fraud alerts on accounts, multifactor authentication prompts, and/or other information.

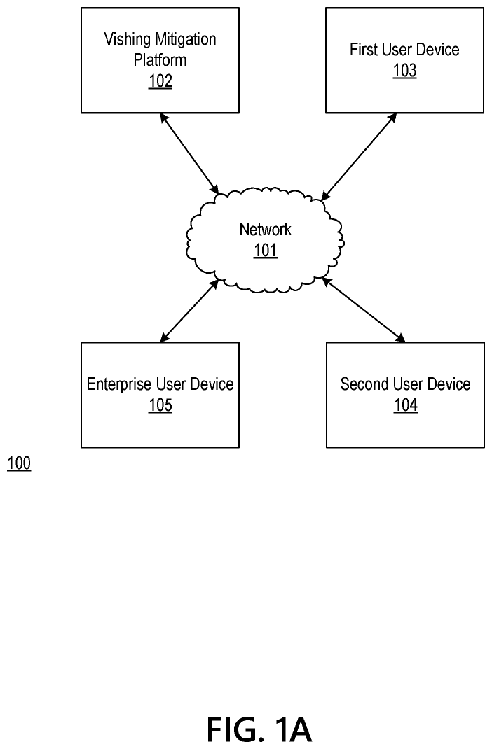

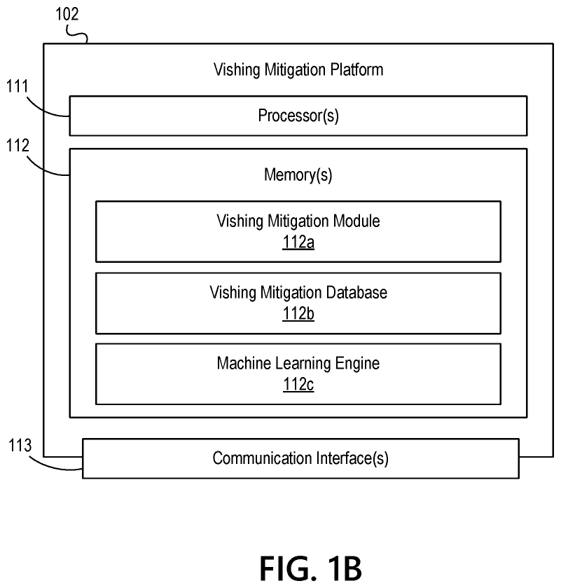

FIGS. 1A-1B depict an illustrative computing environment for generating customized authentication questions for automated vishing detection in accordance with one or more example embodiments. Referring to FIG. 1A, computing environment 100 may include one or more computer systems. For example, computing environment 100 may include vishing mitigation platform 102, first user device 103, second user device 104, and enterprise user device 105.

As described further below, vishing mitigation platform 102 may be a computer system that includes one or more computing devices (e.g., servers, server blades, or the like) and/or other computer components (e.g., processors, memories, communication interfaces) that may be used to provide automated vishing mitigation services. For example, vishing mitigation platform 102 may be configured to train, host, and/or otherwise maintain a model (e.g., a machine learning model, or the like), which may be configured to generate customized authentication questions to validate an identity of a caller.

Although vishing mitigation platform 102 is shown as a distinct system, this is for illustrative purposes only. In some instances, the services provided by the vishing mitigation platform 102 may be accessed, supported, and/or otherwise provided by an application hosted at a user device (e.g., first user device 103).

First user device 103 may be and/or otherwise include a laptop computer, desktop computer, mobile device, tablet, smartphone, and/or other device that may be used by an individual (such as a client/customer of an enterprise organization). In some instances, the first user device 103 may be configured with an application (e.g., corresponding to the enterprise organization, or another enterprise organization), which may be configured to initiate an automated vishing mitigation service upon detecting particular speech using natural language processing. In some instances, first user device 103 may be configured to display one or more user interfaces (e.g., identity validation interfaces, security notifications, or the like).

Second user device 104 may be and/or otherwise include a laptop computer, desktop computer, mobile device, tablet, smartphone, and/or other device that may be used by an individual (who, for illustrative purposes, may be using a chatbot, deepfake, and/or otherwise simulating/impersonating a legitimate employee of an enterprise organization). In some instances, second user device 104 may be configured to display one or more user interfaces (e.g., identify verification interfaces, or the like).

Enterprise user device 105 may be and/or otherwise include a laptop computer, desktop computer, mobile device, tablet, smartphone, and/or other device that may be used by an individual (such as a legitimate employee of an enterprise organization). In some instances, enterprise user device 105 may be configured to display one or more user interfaces (e.g., security notifications, identify validation notifications, or the like).

Although a single vishing mitigation platform 102, enterprise user device 105, and two user devices (first user device 103 and second user device 104) are shown, any number of such devices may be deployed in the systems/methods described below without departing from the scope of the disclosure.

Computing environment 100 also may include one or more networks, which may interconnect vishing mitigation platform 102, first user device 103, second user device 104, enterprise user device 105, or the like. For example, computing environment 100 may include a network 101 (which may interconnect, e.g., vishing mitigation platform 102, first user device 103, second user device 104, enterprise user device 105, or the like).

In one or more arrangements, vishing mitigation platform 102, first user device 103, second user device 104, and enterprise user device 105 may be any type of computing device capable of sending and/or receiving requests and processing the requests accordingly. For example, vishing mitigation platform 102, first user device 103, second user device 104, enterprise user device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of vishing mitigation platform 102, first user device 103, second user device 104, and enterprise user device 105 may, in some instances, be special-purpose computing devices configured to perform specific functions.

Referring to FIG. 1B, vishing mitigation platform 102 may include one or more processors 111, memory 112, and communication interface 113. A data bus may interconnect processor 111, memory 112, and communication interface 113. Communication interface 113 may be a network interface configured to support communication between vishing mitigation platform 102 and one or more networks (e.g., network 101, or the like). Memory 112 may include one or more program modules having instructions that when executed by processor 111 cause vishing mitigation platform 102 to perform one or more functions described herein and/or one or more databases that may store and/or otherwise maintain information which may be used by such program modules and/or processor 111. In some instances, the one or more program modules and/or databases may be stored by and/or maintained in different memory units of vishing mitigation platform 102 and/or by different computing devices that may form and/or otherwise make up vishing mitigation platform 102. For example, memory 112 may have, host, store, and/or include vishing mitigation module 112a, vishing mitigation database 112b, and/or machine learning engine 112c.

Vishing mitigation module 112a may have instructions that direct and/or cause vishing mitigation platform 102 to provide improved vishing mitigation techniques, as discussed in greater detail below. Vishing mitigation database 112b may store information used by vishing mitigation module 112a and/or vishing mitigation platform 102 in application of advanced techniques to provide improved vishing detection and mitigation services, and/or in performing other functions. Machine learning engine 112c may train, host, and/or otherwise refine a model that may be used to perform customized authentication question generation for automated vishing detection and mitigation, and/or other functions.

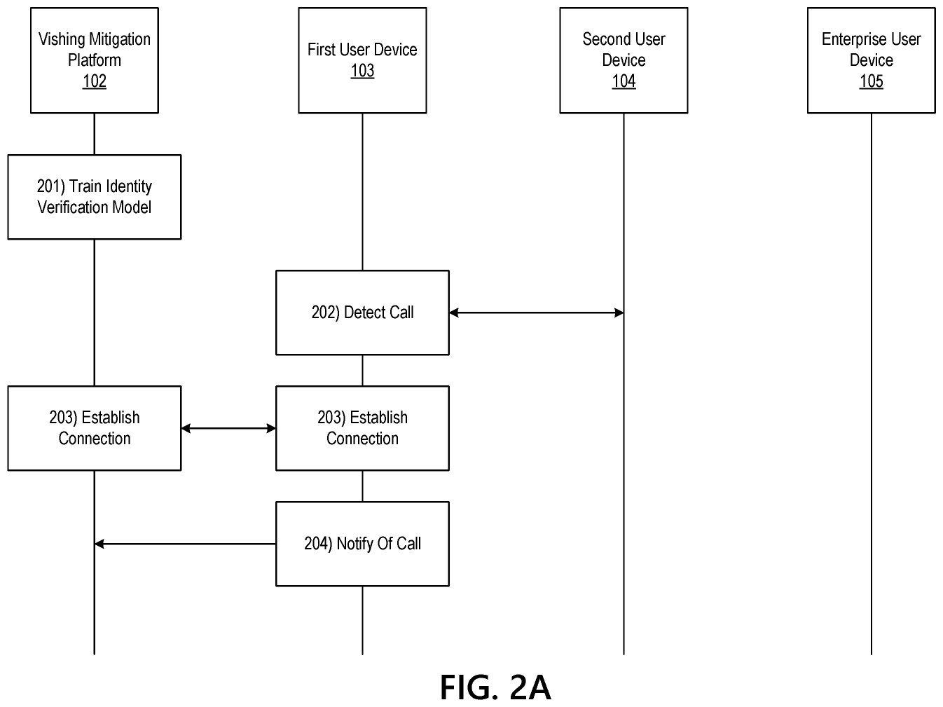

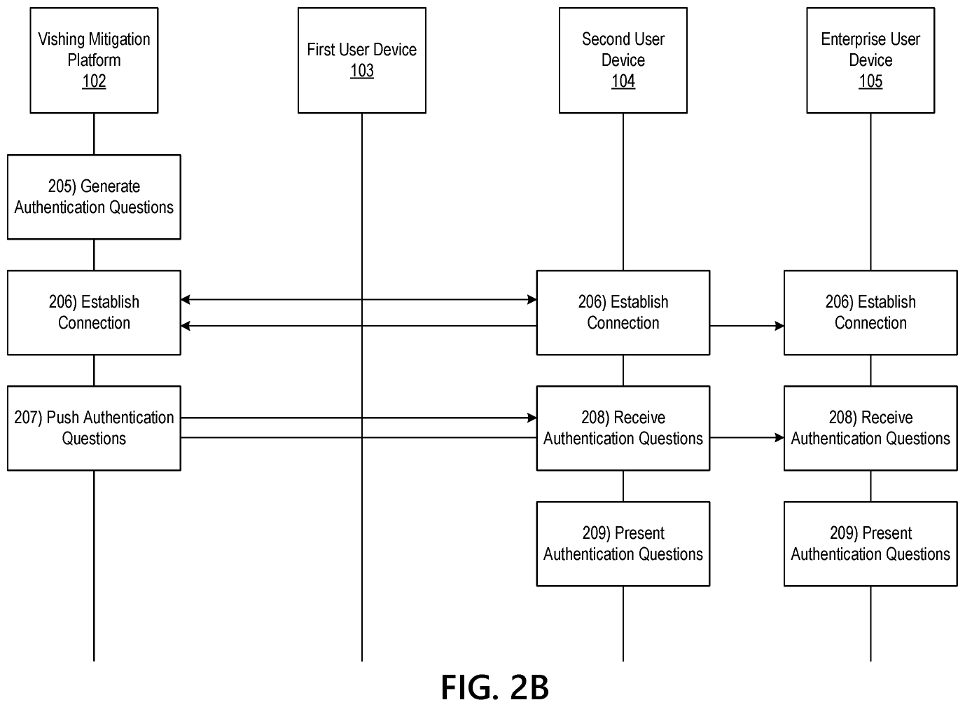

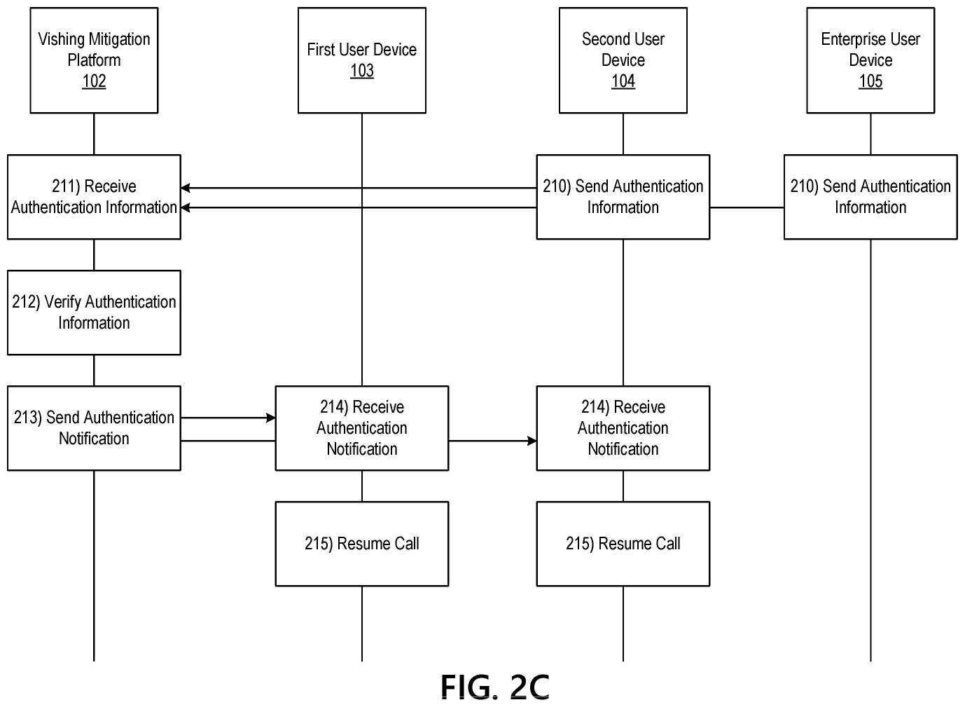

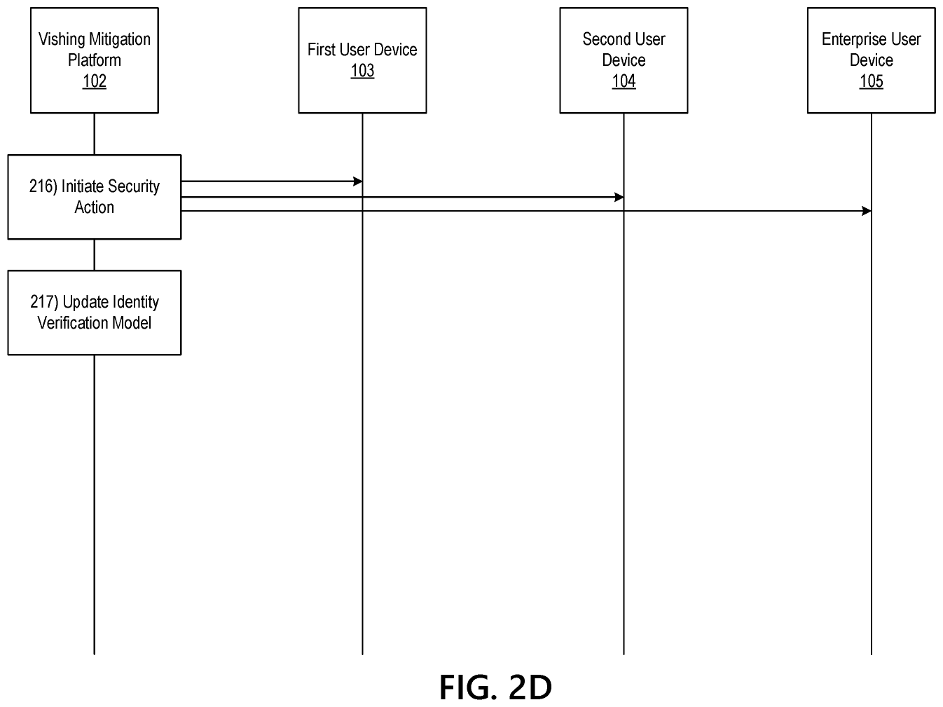

FIGS. 2A-2D depict an illustrative event sequence for generating customized authentication questions for automated vishing detection in accordance with one or more example embodiments. Referring to FIG. 2A, at step 201, the vishing mitigation platform 102 may train a machine learning model (e.g., an identity verification model). For example, the vishing mitigation platform 102 may train the identity verification model to identify authentication questions for a particular individual (e.g., a caller, who may e.g., be a legitimate employee of an enterprise organization, or may be using deepfakes, chatbots, and/or other methods to impersonate a legitimate employee) when engaging in a call with another individual (e.g., a call recipient, who may e.g., be a client of the enterprise organization). For example, the vishing mitigation platform 102 may receive historical call information (e.g., details of topics discussed during previous calls with individuals, call transcripts, or the like), employee information (e.g., line of business, role, start date, previously performed actions, geolocation, and/or other information), enterprise information (e.g., known internal information, or the like), client information (e.g., account information, previously requested actions, registration date, geolocation, and/or other information), previously generated security prompts (e.g., validating an identity of the caller), success/error information corresponding to the prompts, and/or other information. The vishing mitigation platform 102 may input the historical information into the identity verification model to train the identity verification model to establish stored correlations between the authentication questions and various scenarios (e.g., calls between a first individual and a second individual about a particular topic, or the like). In doing so, the vishing mitigation platform 102 may train the identity verification model to identify, based on a call, authentication questions that may be generated to validate a caller identity (which may, e.g., prevent vishing attacks).

In some instances, in training the identity verification model, the vishing mitigation platform 102 may train the identity verification model to identify a confidence score for given authentication questions (e.g., indicating a confidence that the authentication question will not result in a false positive and/or false negative validation result). In some instances, the identity verification model may be trained to compare these confidence scores to one or more thresholds, and select the corresponding questions if their corresponding confidence scores meet or exceed the given thresholds. In some instances, the prompt generation model may be trained to select one or more authentication questions, based on a given call and its corresponding participants.

In some instances, the vishing mitigation platform 102 may further train the identity verification model to identify, based on responses to the authentication questions (e.g., authentication information) and a corresponding scenario, whether or not to validate a particular caller. In some instances, the identity verification model may be trained to validate a particular caller only where all security questions are successfully completed. In other instances, the identity verification model may be trained to validate a particular caller where only a portion of the authentication questions (e.g., at least a threshold number of authentication questions) are successfully completed. In some instances, the identity verification model may be trained to make this identification based on a given scenario (e.g., a topic of the call, the involved parties, or the like).

In some instances, the vishing mitigation platform 102 may further train the identity verification model to identify one or more security actions to perform based on an incorrect response to a given question. For example, in some instances, the vishing mitigation platform 102 may be trained to classify the authentication questions based on a level of difficulty and/or specificity, and be configured to select more intensive security actions as the level of difficulty decreases. For example, the vishing mitigation platform 102 may train the identity verification model to classify questions known to all employees of the enterprise organization as having a first level of difficulty, which may be less than a second level of difficulty, which may be assigned to questions known only to an employee who has previously interacted with a given client (e.g., questions based on that client's transaction history, or the like). Accordingly, the identity verification model may be trained to select a more urgent and/or intensive security action where an easier question is incorrectly answered, as compared to a less urgent and/or intensive security action where a more difficult question is incorrectly answered.

In some instances, in training the identity verification model, the vishing mitigation platform 102 may train a supervised learning model (e.g., decision tree, bagging, boosting, random forest, neural network, linear regression, artificial neural network, support vector machine, and/or other supervised learning model), unsupervised learning model (e.g., classification, clustering, anomaly detection, feature engineering, feature learning, and/or other unsupervised learning models), and/or other model.

At step 202, the first user device 103 may detect a call between the first user device 103 and the second user device 104 or enterprise user device 105. For example, the first user device 103 may be configured with an application that may use natural language processing to trigger analysis by the vishing mitigation platform 102. For example, the application may be executed to identify particular words or language corresponding to an enterprise associated with the application (e.g., a particular service, or the like), and to trigger the vishing mitigation detection accordingly. In some instances, the application may detect an audio signal at the first user device 103 itself and/or another device (e.g., hard-wired phone, computer, or the like). For example, in some instances, an audio or other voice sensor may be attached or otherwise integrated into a landline device, or the like.

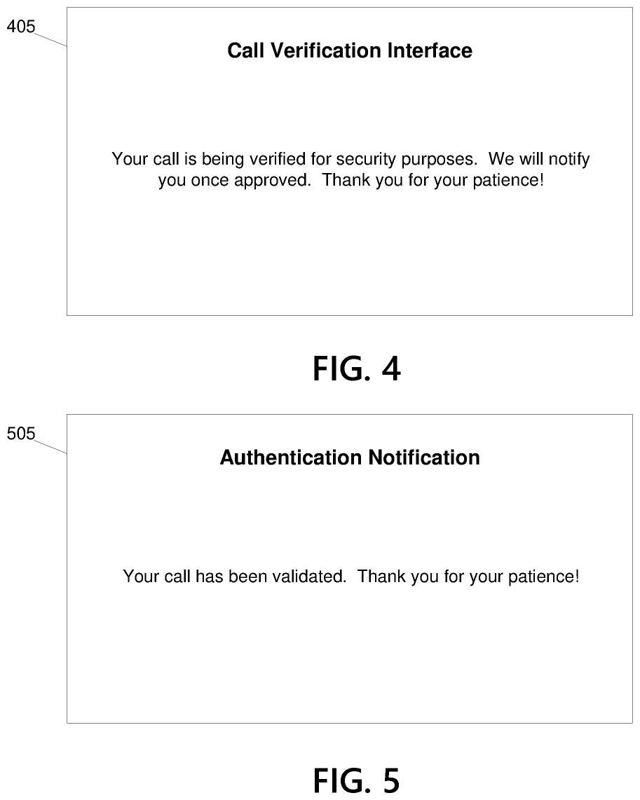

In some instances, once detected, the first user device 103 may pause the call. For example. The first user device 103 may receive (e.g., from the vishing mitigation platform 102) and display a graphical user interface similar to graphical user interface 405, which is shown in FIG. 4.

At step 203, the first user device 103 may establish a connection with the vishing mitigation platform 102. For example, the first user device 103 may establish a first wireless data connection with the vishing mitigation platform 102 to link the first user device 103 to the vishing mitigation platform 102 (e.g., in preparation for notifying the vishing mitigation platform 102 of the detected call). In some instances, the vishing mitigation platform 102 may identify whether or not a connection is already established with the vishing mitigation platform 102. If a connection is already established with the vishing mitigation platform 102, the first user device 103 might not re-establish the connection. If a connection is not yet established with the vishing mitigation platform 102, the first user device 103 may identify the first wireless data connection as described herein.

At step 204, the first user device 103 may notify the vishing mitigation platform 102 of the detected call. For example, the first user device 103 may send a notification and/or other trigger signal to the vishing mitigation platform 102. In some instances, the first user device 103 may notify the vishing mitigation platform 102 of the call while the first wireless data connection is established.

Referring to FIG. 2B, at step 205, vishing mitigation platform 102 may generate one or more authentication questions. For example, the vishing mitigation platform 102 may input information of the call into the identity verification model. For example, the vishing mitigation platform 102 may input call information (e.g., a topic being discussed), a caller identifier (e.g., representative of a user of the second user device 104), a recipient identifier (e.g., representative of a user of the first user device 103), and/or other information into the identity verification model to generate corresponding authentication questions. For example, the identity verification model may output one or more authentication questions. The identity verification model may score the one or more authentication questions based on the corresponding error rates associated with the given prompts (where a lower score indicates a higher error rate and a higher score indicates a lower error rate), and may select one or more authentication questions with the highest scores (e.g., the authentication questions may be ranked based on scores, or the like). In some instances, the identity verification model may generate the one or more authentication questions based on identifying similar (e.g., at least a predetermined threshold amount of matching information) call conditions to historical call information (e.g., similar topics, similar participants, or the like), and may generate authentication questions based on information associated with a valid employee or other user (e.g., what day, month, year, or the like did they start work, what is their line of business, who is their manager, or the like), information known to employees of the enterprise organization (e.g., a current loan rate, information from a recent company wide message, or the like), information associated with the user of the first user device (e.g., account information, a day, month, year, or the like of a previous communication with the user of the first user device, identity information, or the like), information associated with a previous call session with the user of the first user device 103 (e.g., a context of the call, questions asked during the call, solutions provided during the call, and/or other information), and/or other information.

In some instances, the vishing mitigation platform 102 may generate the authentication questions based entirely or in part based on information from the first user device 103. For example, the vishing mitigation platform 102 may send one or more of the authentication questions to the first user device 103 to provide feedback (e.g., is it reasonable that the employee would know this information, is this context of a prior conversation correct, or the like) on automatically generated questions and/or provide responses to automatically generated questions (e.g., provide a context of a previous conversation, or the like). Additionally or alternatively, the vishing mitigation platform 102 may request that the user of the first user device 103 provide questions and their corresponding responses (e.g., allow the user of the first user device 103 to manually define questions/answers to be presented).

In some instances, the vishing mitigation platform 102 may generate the authentication questions based, at least in part, on social media information associated with the user of the first user device 103. For example, the vishing mitigation platform 102 may identify whether answers to any of the authentication questions may be revealed for the user in their social media information (e.g., they reveal their birthday, or the like). In these instances, the vishing mitigation platform 102 may filter out (and thus not select) authentication questions corresponding to any such information, as it may be available to a bad actor and thus used to circumvent the security measures imposed by the authentication questions.

In some instances, the vishing mitigation platform 102 may generate a plurality of authentication questions, which may, e.g., have a corresponding sequence in which the authentication questions should be presented (e.g., from most general to most specific, or the like). For example, in some instances, the vishing mitigation platform 102 may generate a sequence of authentication questions that includes a first question specific to the entire enterprise organization, a second question specific to a valid employee, and a third question specific to a prior interaction of that valid employee with a client, or the like. In these instances, the vishing mitigation platform 102 may assign each authentication question to a specificity tier and/or otherwise assign a specificity score to the questions.

By dynamically creating and/or changing the authentication questions in this way, the employee validation process may prevent bots from being trained on the prompts, thus enabling them to circumvent any imposed security measures. In some instances, in generating the authentication questions, the vishing mitigation platform 102 may generate a graphical user interface, notification, or the like that may display a textual prompt. In some instances, this textual prompt may prompt for selection of a user interface element corresponding to a particular answer (e.g., choose A, B, or C, or the like), prompt for a natural language text input (e.g., please type your answer below, or the like). Additionally or alternatively, the vishing mitigation platform 102 may generate an audio or other voice based prompt that may be presented. In some instances, the vishing mitigation platform 102 may generate authentication questions that are, in essence, decoys. For example, the vishing mitigation platform 102 may generate authentication questions prompting for information that might not exist (e.g., a home loan date when the user does not own a home, or the like) in an attempt to lure an impersonator to reveal themselves by responding to the question (whereas a valid user may response with N/A, or the like).

At step 206, the vishing mitigation platform 102 may establish connections with the second user device 104 and/or enterprise user device 105. For example, the vishing mitigation platform 102 may establish second and/or third wireless data connections with the second user device 104 and/or enterprise user device 105, respectively, to link the vishing mitigation platform 102 to the second user device 104 and/or enterprise user device 105 (e.g., in preparation for sending the one or more authentication questions). In some instances, the vishing mitigation platform 102 may identify whether or not connections are already established with the second user device 104 and/or the enterprise user device 105. If connections are not yet established, the vishing mitigation platform 102 may establish the second and/or third wireless data connections accordingly. If connections are already established, the vishing mitigation platform 102 might not re-establish the connections.

At step 207, the vishing mitigation platform 102 may push the one or more authentication questions to the second user device 104 and/or the enterprise user device 105. For example, the vishing mitigation platform 102 may push the one or more authentication questions to the second user device 104 and/or the enterprise user device 105 via the communication interface 113 and while the second and/or third wireless data connections are established. In some instances, the vishing mitigation platform 102 may also send one or more commands directing the second user device 104 and/or enterprise user device 105 to present the one or more authentication questions.

At step 208, the second user device 104 and/or enterprise user device 105 may receive the one or more authentication questions(s) sent at step 207. For example, the second user device 104 and/or enterprise user device 105 may receive the authentication questions while the second and/or third wireless data connections are established.

At step 209, based on or in response to the one or more commands directing the second user device 104 and/or the enterprise user device 105 to present the one or more authentication questions, the second user device 104 and/or the enterprise user device 105 may present the authentication questions. For example, the second user device 104 and/or the enterprise user device 105 may present a graphical user interface that includes the authentication questions, present an audio output that includes the authentication questions, or the like. In some instances, the second user device 104 may present the authentication questions in a predefined sequence specified by the vishing mitigation platform 102.

Referring to FIG. 2C, at step 210, the second user device 104 and/or enterprise user device 105 may receive authentication information in response to the one or more authentication questions (e.g., in response to the requested information). In some instances, the second user device 104 and/or enterprise user device 105 may provide a limited number of chances to input the correct authentication information. The second user device 104 and/or enterprise user device 105 may send the authentication information to the vishing mitigation platform 102. For example, the second user device 104 and/or enterprise user device 105 may send the authentication information while the second and/or third wireless data connections are established. In some instances, the second user device 104 and/or enterprise user device 105 may receive a touch input, textual input, voice input, and/or other input of the authentication information.

At step 211, the vishing mitigation platform 102 may receive the authentication information sent at step 210. For example, the vishing mitigation platform 102 may receive the authentication information via the communication interface 113 and while the second and/or third wireless data connection is established. In some instances, the vishing mitigation platform 102 may continually loop back to step 207 until all authentication questions have been sent and the corresponding authentication information has been received. In other instances, the vishing mitigation platform 102 may proceed to validate first authentication, in response to a first authentication question (e.g., as described further at step 212 below), before looping back to step 207.

At step 212, the vishing mitigation platform 102 may validate the authentication information. For example, the vishing mitigation platform 102 may identify whether or not the authentication information matches the anticipated authentication information. In some instances, the vishing mitigation platform 102 may identify whether authentication information corresponding to all of the authentication questions is valid (e.g., the vishing mitigation platform 102 may cause all authentication questions to be presented prior to validation). In other instances, the vishing mitigation platform 102 may have caused a single authentication question to be presented, and may then validate the corresponding authentication information before looping back to step 207 to present a subsequent authentication question. In these instances, if the vishing mitigation platform 102 identifies that the authentication information for a particular authentication question is incorrect, the vishing mitigation platform 102 may identify whether to loop back and re-present the authentication question, present a subsequent authentication question, initiate one or more security actions, and/or perform other actions. For example, the vishing mitigation platform 102 may make this determination based on a specificity/difficulty level or score of the authentication question (e.g., first level, second level, third level, or the like where the first level is easier than the second level and so on), a degree to which the authentication information is incorrect (e.g., minor spelling error vs. completely wrong, or the like), and/or otherwise. For example, in instances where an easy authentication question is missed and/or if the authentication information is significantly different than expected authentication information, this may be a red flag and the vishing mitigation platform 102 may proceed to step 216 without presenting any remaining intervening authentication questions. In contrast, if a more difficult authentication question is missed and/or if the authentication information includes a minor spelling or other mistake, the vishing mitigation platform 102 may return to step 207 to provide a user with a second change at the question, present an alternative question, or the like.

In instances where the vishing mitigation platform 102 identifies that the authentication information (or at least a threshold amount of the authentication information) is valid, the vishing mitigation platform 102 may proceed to step 213. Otherwise, if the vishing mitigation platform 102 identifies that the authentication information (or at least the threshold amount of the authentication information) is not valid, the vishing mitigation platform 102 may proceed to step 216.

At step 213, the vishing mitigation platform 102 may send an authentication notification to the first user device 103 and/or second user device 104. For example, the vishing mitigation platform 102 may send an authentication notification to the first user device 103 and/or second user device 104 via the communication interface 113 and while the first and/or second wireless data connections are established. In some instances, the vishing mitigation platform 102 may also send one or more commands directing the first user device 103 and/or second user device 104 to display the authentication notification.

At step 214, the first user device 103 and/or the second user device 104 may receive the authentication notification sent at step 213. For example, the first user device 103 and/or the second user device 104 may receive the authentication notification while the first and/or second wireless data connection is established. In some instances, the first user device 103 and/or second user device 104 may also receive the one or more commands directing the second user device 104 to display the authentication notification.

At step 215, the first user device 103 and/or second user device 104 may cause the call to resume. In some instances, based on the one or more commands directing the second user device 104 to display the authentication notification, the second user device 104 may display the authentication notification. For example, the first user device 103 and/or second user device 104 may display a graphical user interface similar to graphical user interface 505, which is illustrated in FIG. 5. The event sequence may then proceed to step 217, where the identity verification model may be updated, as is described below.

Returning to step 212, if the vishing mitigation platform 102 identified that the authentication information is not valid, it may have proceeded to step 216, as is depicted in FIG. 2D. Referring to FIG. 2D, at step 216, the vishing mitigation platform 102 may identify that the call was initiated using a deepfake, chatbot, and/or other impersonation technique, may initiate one or more security actions. For example, the vishing mitigation platform 102 may send a notification to the enterprise user device 105 (which may, e.g., correspond to an employee being impersonated via the second user device 104), and which may notify the enterprise user device 105 of the detected vishing attempt. In these instances, the vishing mitigation platform 102 may send one or more commands directing the enterprise user device 105 to display the security notification, which may, e.g., cause the enterprise user device 105 to display the security notification. Additionally or alternatively, the vishing mitigation platform 102 may send a recording of the call to an administrator for further analysis.

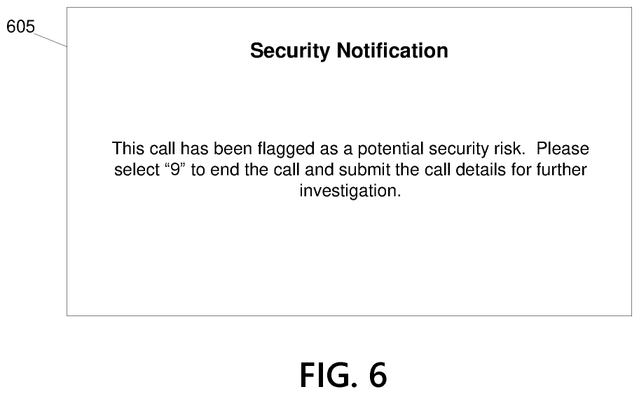

Additionally or alternatively, the vishing mitigation platform 102 may communicate with the first user device 103 and/or second user device 104 to terminate the call. Additionally or alternatively, the vishing mitigation platform 102 may send a security notification to the first user device 103, which may inform the first user device 103 of the detected vishing threat, and prompting a corresponding user to terminate the call. For example, the vishing mitigation platform 102 may send a notification similar to graphical user interface 605, which is illustrated in FIG. 6. Additionally or alternatively, the vishing mitigation platform 102 may allow the call to continue/resume, but may notify the user of the first user device 103, and may initiate a recording of the call. Additionally or alternatively, the vishing mitigation may end the call and may provide the user of the first user device 103 with a number of a valid employee of the enterprise, have the valid employee reach out to the user, or the like. In instances where a valid employee is directed to reach out to the user, they may be pre-authenticated prior to being connected with the user. In some instances, the vishing mitigation platform 102 may send a notification to the first user device 103 indicating that they may terminate the call at any time by pressing a particular key or interface element on their device (e.g., “press 9 to disconnect at anytime,” or the like).

At step 217, the vishing mitigation platform 102 may update the identity verification model based on the one or more authentication questions, the authentication information, results of the validation, information of the call participants, information of the call, user feedback on the validation, and/or other information. In doing so, the vishing mitigation platform 102 may continue to refine the identity verification model using a dynamic feedback loop, which may, e.g., increase the accuracy and effectiveness of the model in detecting and mitigating vishing attacks.

For example, the vishing mitigation platform 102 may use the one or more authentication questions, the authentication information, results of the validation, information of the call participants, information of the call, user feedback on the validation, and/or other information to reinforce, modify, and/or otherwise update the identity verification model, thus causing the model to continuously improve (e.g., in terms of performing authentication question generation for vishing detection/mitigation).

For example, in some instances, the vishing mitigation platform 102 may update the identity verification model to include new authentication questions, remove existing authentication questions, and/or otherwise modify the available authentication questions for selection based on receiving consensus feedback information indicating that the one or more authentication questions resulted in one of a false positive validation or a false negative validation. In doing so, the vishing mitigation platform 102 may minimize an error rate corresponding to authentication questions.

In some instances, the vishing mitigation platform 102 may continuously refine the identity verification model. In some instances, the vishing mitigation platform 102 may maintain an accuracy threshold for the identity verification model, and may pause refinement (through the dynamic feedback loops) of the model if the corresponding accuracy is identified as greater than the corresponding accuracy threshold. Similarly, if the accuracy fails to be equal or less than the given accuracy threshold, the vishing mitigation platform 102 may resume refinement of the model through the corresponding dynamic feedback loop.

In doing so, subsequent communications may be analyzed by the identity verification model based on the configuration information identified above, and thus question generation for automated detection/mitigation of vishing attacks may continuously improve. By operating in this way, the vishing mitigation platform 102 may automatically detect and mitigate vishing attacks, thus maintaining information security.

In some instances, the above described methods may be performed for calls initiated by enterprise employees (e.g., internally originating calls), initiated by customers (e.g., externally originating calls), and/or impersonation attempts.

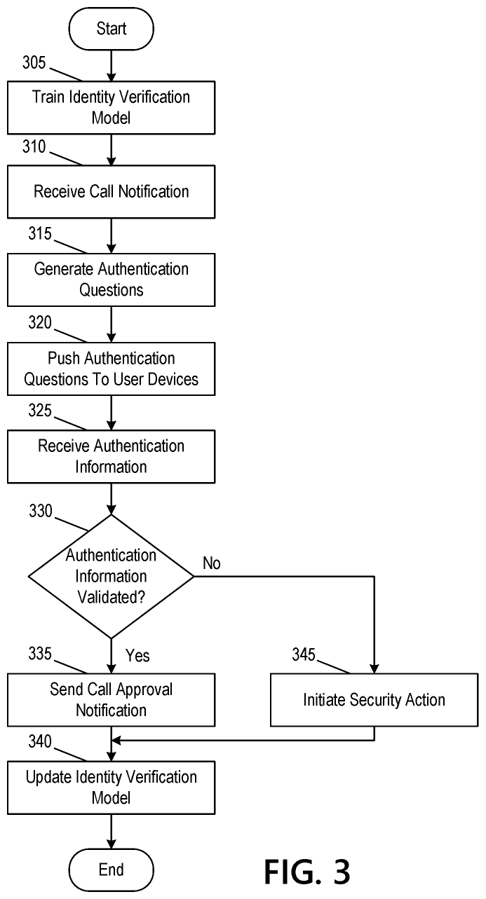

FIG. 3 depicts an illustrative method for generating customized authentication questions for automated vishing detection in accordance with one or more example embodiments. At step 305, a computing platform having at least one processor, a communication interface, and memory may train an identity verification model. At step 310, the computing platform may receive a call notification, indicating a call between two individuals (e.g., between a first device of a first individual and a second device of a second individual) and may pause the call accordingly. At step 315, the computing platform may generate, using the identity verification model, one or more authentication questions, configured to prompt an initiator of the call for authentication information (which may, e.g., be used to validate an identity of the initiator). At step 320, the computing platform may push the one or more authentication questions to the first and/or second user devices. At step 325, the computing platform may receive authentication information from the initiator's user device. At step 330, the computing platform may attempt to validate the authentication information. If the security input information is validated, the computing platform may proceed to step 335.

At step 335, the computing platform may send a call approval notification to the user devices of the two individuals, which may cause the call to resume. At step 340, the computing platform may update the identity verification model.

Returning to step 330, if the authentication information is not validated, the computing platform may proceed to step 345. At step 345, the computing platform may initiate a security action for the call. The computing platform may then proceed to step 340 to update the identity verification model as described above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, using historical call information, an identity verification model, wherein training the identity verification model configures the identity verification model to identify, for an initiated call between a first individual and a second individual, one or more authentication questions to validate an identity of the first individual;
detect a first call between the first individual and the second individual, wherein the first individual comprises one of: an employee of an enterprise or an impersonator of the employee of the enterprise;
temporarily pause the first call;
input, into the identity verification model and while the first call is paused, information of one or more of: the first call, the first individual, or the second individual, wherein inputting the information causes the identity verification model to output the one or more authentication questions;
send, while the first call is paused and to a user device of the first individual, the one or more authentication questions and one or more commands directing the user device of the first individual to present the one or more authentication questions, wherein sending the one or more commands directing the user device of the first individual to present the one or more authentication questions causes the user device of the first individual to output the one or more authentication questions;
receive, while the first call is paused and from the user device of the first individual, authentication information comprising responses to the one or more authentication questions;
validate, while the first call is paused, the authentication information; and
based on successful validation of the authentication information, cause the first call to resume.

2. The computing platform of claim 1, wherein the historical call information comprises one or more of: employee information corresponding to the first individual, enterprise information corresponding to the enterprise, customer information corresponding to the second individual, account information corresponding to the second individual, or details of historical calls between the second individual and the enterprise.

3. The computing platform of claim 2, wherein the details of the historical calls between the second individual and the enterprise comprise transcripts of the historical calls.

4. The computing platform of claim 1, wherein the one or more authentication questions further comprise one or more personalized questions for the first individual.

5. The computing platform of claim 1, wherein the one or more authentication questions prompt the first individual to verify one or more of: employee information corresponding to the first individual, enterprise information corresponding to the enterprise, customer information corresponding to the second individual, account information corresponding to the second individual, or details of historical calls between the second individual and the enterprise.

6. The computing platform of claim 1, wherein outputting the one or more authentication questions comprises outputting a sequence of at least two authentication questions, wherein the at least two authentication questions are configured to be presented in the sequence and increase in specificity as the sequence progresses.

7. The computing platform of claim 1, wherein the memory stores additional computer-readable instructions that, when executed by the at least one processor, further cause the computing platform to:
send, to a user device of the second individual and prior to sending the one or more authentication questions to the user device of the first individual, the one or more authentication questions and a request to confirm the one or more authentication questions.

8. The computing platform of claim 7, wherein the request to confirm the one or more authentication questions comprises a request to confirm one or more of:
the one or more authentication questions are accurate measures for validating an identity of the first individual, or
responses to the one or more authentication questions that may be used to validate the authentication information.

9. The computing platform of claim 1, wherein the first call is initiated by one of: the first individual or the second individual.

10. The computing platform of claim 1, wherein presenting the one or more authentication questions comprises one or more of:
displaying the one or more authentication questions on a graphical user interface of the user device of the first individual, or
causing the one or more authentication questions to be presented, at the user device of the first individual, as an audio output.

11. The computing platform of claim 1, wherein receiving the authentication information comprises receiving one or more of:
a user input via a graphical user interface of the user device of the first individual, wherein the user input comprises one or more of:
a selection of a user interface element corresponding to the authentication information, or
a natural language input in a text input field, or
a voice input corresponding to the authentication information.

12. The computing platform of claim 1, wherein validating the authentication information comprises comparing the authentication information to known valid responses to the authentication questions.

13. The computing platform of claim 1, wherein the memory stores additional computer-readable instructions that, when executed by the at least one processor, further cause the computing platform to:
based on failing to successfully validate the authentication information:
identify that the first individual is an impersonator,
terminate the first call, and
initiate one or more security actions.

14. The computing platform of claim 1, wherein the memory stores additional computer-readable instructions that, when executed by the at least one processor, further cause the computing platform to:
update, using a dynamic feedback loop and based on the one or more authentication questions, the authentication information, the information of the first individual, the information of the second individual, or the information of the first call, the identity verification model.

15. The computing platform of claim 14, wherein updating the identity verification model causes the identity verification model to perform one or more of: adding new authentication questions or removing the one or more authentication questions based on receiving consensus information from a plurality of individuals indicating that the one or more authentication questions resulted in one of: a false positive validation or a false negative validation.

16. The computing platform of claim 1, wherein detecting the first call between the first individual and the second individual comprises detecting the first call by one of:
a mobile device of the second individual being used to perform the first call, or
a voice sensor attached to a landline phone being used to perform the first call.

17. A method comprising:
at a computing platform comprising at least one processor, a communication interface, and memory:
training, using historical call information, an identity verification model, wherein training the identity verification model configures the identity verification model to identify, for an initiated call between a first individual and a second individual, one or more authentication questions to validate an identity of the first individual;
detecting a first call between the first individual and the second individual, wherein the first individual comprises one of: an employee of an enterprise or an impersonator of the employee of the enterprise;
temporarily pausing the first call;
inputting, into the identity verification model and while the first call is paused, information of one or more of: the first call, the first individual, or the second individual, wherein inputting the information causes the identity verification model to output the one or more authentication questions;
sending, while the first call is paused and to a user device of the first individual, the one or more authentication questions and one or more commands directing the user device of the first individual to present the one or more authentication questions, wherein sending the one or more commands directing the user device of the first individual to present the one or more authentication questions causes the user device of the first individual to output the one or more authentication questions;
receiving, while the first call is paused and from the user device of the first individual, authentication information comprising responses to the one or more authentication questions;
validating, while the first call is paused, the authentication information; and
based on successful validation of the authentication information, causing the first call to resume.

18. The method of claim 17, wherein the historical call information comprises one or more of: employee information corresponding to the first individual, enterprise information corresponding to the enterprise, customer information corresponding to the second individual, account information corresponding to the second individual, or details of historical calls between the second individual and the enterprise.

19. The method of claim 18, wherein the details of the historical calls between the second individual and the enterprise comprise transcripts of the historical calls.

20. One or more non-transitory computer-readable media storing instructions that, when executed by a computing platform comprising at least one processor, a communication interface, and memory, cause the computing platform to:
train, using historical call information, an identity verification model, wherein training the identity verification model configures the identity verification model to identify, for an initiated call between a first individual and a second individual, one or more authentication questions to validate an identity of the first individual;
detect a first call between the first individual and the second individual, wherein the first individual comprises one of: an employee of an enterprise or an impersonator of the employee of the enterprise;
temporarily pause the first call;
input, into the identity verification model and while the first call is paused, information of one or more of: the first call, the first individual, or the second individual, wherein inputting the information causes the identity verification model to output the one or more authentication questions;
send, while the first call is paused and to a user device of the first individual, the one or more authentication questions and one or more commands directing the user device of the first individual to present the one or more authentication questions, wherein sending the one or more commands directing the user device of the first individual to present the one or more authentication questions causes the user device of the first individual to output the one or more authentication questions;
receive, while the first call is paused and from the user device of the first individual, authentication information comprising responses to the one or more authentication questions;
validate, while the first call is paused, the authentication information; and
based on successful validation of the authentication information, cause the first call to resume.
